(19) United States
(12) Patent Application Publication
(10) Pub. No.: US 2002/0134400 A1
(43) Pub. Date: Sep. 26, 2002

(54) Method for cleaning oxidized hot rolled copper rods

(76) Inventors: Michael Schwarze, Schwalmtal (DE); Herbert Berendes, Mulheim (DE); Jurgen Jacob, Bottrop (DE)

Correspondence Address: Thomas C Pontani, Cohen Pontani Lieberman & Pavane, 551 Fifth Avenue, Suite 1210, New York, NY, 10176, US

(21) Appl. No.: 10/030,670

(22) PCT Filed: May 8, 2001
(86) PCT No.: PCT/DE01/01791

(30) Foreign Application Priority Data
May 10, 2000 (DE) 100 23 480.1

(51) Int. Cl. C23G 1/00; B08B 7/04

(52) U.S. Cl. 134/1; 134/2; 134/26

(57) ABSTRACT

The invention relates to a process for cleaning oxidized, rolled copper rods which, after casting in a continuously operating continuous-casting device, emerge from a rolling mill arranged downstream of the continuous-casting device and which, on emerging from the rolling mill, have oxidic layers on their surface. The process is characterized, inter alia, in that the oxidized, finish-rolled rod is passed through one or more reduction zones at a temperature of approx. 650° C.; in that a dilute, aqueous hydrocarbon-containing solution is used as reducing liquid in the reduction zone(s), and in that the rate at which the chemical reactions for reducing the two types of oxide which are present is made more intensive by making the bath turbulent by means of one or more ultrasound sources.

### DESCRIPTION

The invention relates to a process for cleaning oxidized, hot-rolled copper rods (rolled copper wire) which, after casting in a continuously operating continuous-casting device, emerge from a rolling mill arranged downstream of the continuous-casting device and which, on emerging from the rolling mill, have oxidized layers on their surface.

In particular, the invention relates to the controlled cooling and cleaning of the cast and rolled rod before it is coiled and/or subjected to a drawing treatment in order to produce fine wire.

During the production of continuously cast copper rods, the strand which leaves the casting device is generally hot-rolled immediately and since the rod is exposed to atmosphere, it is oxidized, and scale builds up on the surface, the scale representing a mixture of copper oxide CuO (red) and copper oxide Cu₂O (black). These oxides have to be removed or converted back into the metallic state before the rod can be subjected to a drawing treatment in order to produce a wire product which can be marketed. The removal of the oxides is also necessary in order to prevent premature wear to the drawing tools and the like.

Hitherto, various processes have been proposed for removing the oxides from the surface of products produced on the basis of copper. It should be noted that, in the present context, the term “copper” is also intended to encompass copper alloys. A number of typical processes which have been proposed for descaling are as follows:

1. Mechanical removal of the scale, for example by sandblasting, shaving, peeling or the like,

2. Removal of the scale by means of acid (pickling),

3. Vapor or gas reduction of the scale,

4. Reduction of the scale using alcohol/benzene/water mixtures.

The production of rolled copper wire using processes in which acid pickling for descaling copper rods is carried out by immersing the rods in a dilute, aqueous acid solution, for example in sulfuric acid, after the cast rods leave the rolling mill but before they have reached the coiling device. To maintain optimum operating conditions with regard to the cleaning, the pickling solution has to be constantly regenerated. For this purpose, the used solution is passed through an electrolysis device in order to recover the copper, and fresh acid is also supplied periodically.

This process is characterized by high investment costs and high operating costs which result from the need to use acid-resistant materials and to avoid ecological problems associated with the discharge of used acids.

Other techniques, in which one or more gases or vapors are used as reducing agent for treating oxidized copper rods, are described in the relevant literature. It is demonstrated that the oxide scale can be removed by initially exposing the rod to reducing gases or vapors at high temperature and immediately afterwards quenching it in a cooling bath before the rod is exposed to atmosphere.

Although this gas reduction appears to have a number of advantages over the acid pickling, the gas reduction also has certain drawbacks. For example, the gases or vapors which are referred to as being suitable for the reduction of copper rods are flammable, toxic or both and therefore require special handling in order to avoid a risk of explosions or asphyxiation or the like. Moreover, oxygen-free atmospheres at elevated temperatures have to be provided, which requires special seals. A further drawback of the gas reduction processes is that the reaction rates are significantly lower than with the processes in which a liquid is brought into contact with the strand.

Aqueous solutions comprising alcohols, ketones or amine compounds, which are used to reduce the said oxides, were used to remove the acid pickle.

The surface quality achieved, measured as the residual oxide layer thickness of the cooled end product, however, is so dependent on the reagents used, on the product throughput rate and the reaction rate, that these reduction lines fall well short of the quality achieved by an acid pickle.

Techniques for making the cleaning process more intensive, in which the process of acid pickling (i.e. the removal and dissolution of the oxides) is accelerated by using electrolytic circuits or ultrasound sources, are known from the Fe processing sector. Processes in which simply the cavitation caused by the ultrasound source effects a mechanical cleaning process, for example removing greases, emulsions, etc., are also known.

For example, it is known from U.S. Pat. No. 5,409,594 to clean the surface of elongated metal objects, such as wire, by means of ultrasound, the wire being passed through a bath which is filled with cleaning solution and in which two ultrasonic transducers are located. The high-frequency ultrasound waves produced by these transducers generate pressure waves, by means of which the scale is detached from the wire.

In the process described in EP 0 518 850 A1, electrolytic pickling of metal strips is carried out, two successive vessels, which are filled with aqueous electrolytes, being provided and a cathodic treatment being carried out in the first vessel and an anodic treatment being carried out in the second vessel.

Since the processes used for the rolled copper wire industry, namely acid pickling or reduction by alcohols, are characterized by high investment/process costs or by an insufficient surface quality and the increasing automization of drawing operations and the further development of drawing technology to form multiple drawing machines places ever higher demands on the surface quality of the copper precursor product, more intensive and more efficient cleaning processes have become necessary.

The invention is based on the object of providing a process which can be used to remove oxidic surface layers on copper rods in a particularly simple and advantageous way, without using acid solutions.

According to the invention, this object is achieved, in a process for cleaning oxidized, rolled copper rods which, after casting in a continuously operating continuous-casting device, emerge from a rolling mill arranged downstream of the continuous-casting device and which, on emerging from the rolling mill, have oxidic layers on their surface, by the fact that the strand being rolled, first of all, is wetted with an emulsion, to which a hydrocarbon-containing reducing agent has been admixed, as early as during the hot-rolling process, in order at least to prevent oxidation of the hot strand during the rolling process. Then, the oxidized, finish-rolled rod is passed through one or more reduction zones at a temperature of approx. 650° C., a dilute, aqueous hydrocarbon-containing solution being used as reducing liquid in the reduction zone(s).

The quantity of reducing liquid used in this case is limited in the descaling section to approx. 10% to 35% of the total quantity of circulating liquid for the descaling and cooling section.

The fact that the oxidized, rolled rod is brought into contact with the cooler, nonacidic, liquid reducing agent means that the oxidized layers of the rod are converted into metal.

The nonacidic, liquid reducing agent is continuously recirculated, cooled and the pH and chemical composition of the recirculated reducing agent are kept constant.

The rate of the chemical reactions which proceed for reduction of the two types of oxide which are present is made more intensive by making the bath turbulent by means of one or more ultrasound sources, so that both the surface quality is improved and the length of the reduction zone is reduced.

The cooling of the rolled rod takes place intensively in one or more subsequent cooling segments using a large quantity of the reducing liquid and the rod is dried by means of mechanical strippers, which are acted on by compressed air, before the deoxidized rod is coated with a wax to protect against renewed oxidation.

Preferred configurations will emerge from the subclaims.

The particular feature of the descaling of hot-rolled copper rods compared to the removal of scale from steel or iron products lies in the structure of the oxide layers on the copper surface, their different adhesion to the surface and their ability to react with acids or reducing agents. The problems are dealt with in depth in an article by Prof. Horace Pops and Daniel R. Hennessy “The Role of Surface Oxide and its measurement in the Copper Wire Industry” Essex Group Incl, United Technology Corp. Metals Laboratory.

The reduction of the oxide layers using hydrocarbon compounds takes place with the formation of liquid reaction products.

e.g. CuO+CₘHₙOₚ→Cu+CₘHₙ₋₂Oₚ+H₂O

It can be seen from this that the continuous supply of fresh reducing agent or the removal of the reaction products from the boundary surface of the copper rods are of decisive importance for the rapid conclusion of this reaction. For this reason, the activating action produced by more intensive mixing of the layers close to the boundary surface with the remainder of the medium by means of the ultrasound source is of decisive importance in breaking down the laminar layer structure of the liquid around the rod in the transitions to the descaling section.

In the process according to the invention, this is achieved by the turbulent flow of the pickling medium produced by the means of the ultrasonic transducers, which operate in the frequency range from 20-3000 kHz.

The process according to the invention is to be explained below on the basis of an installation shown in the drawings, in which:

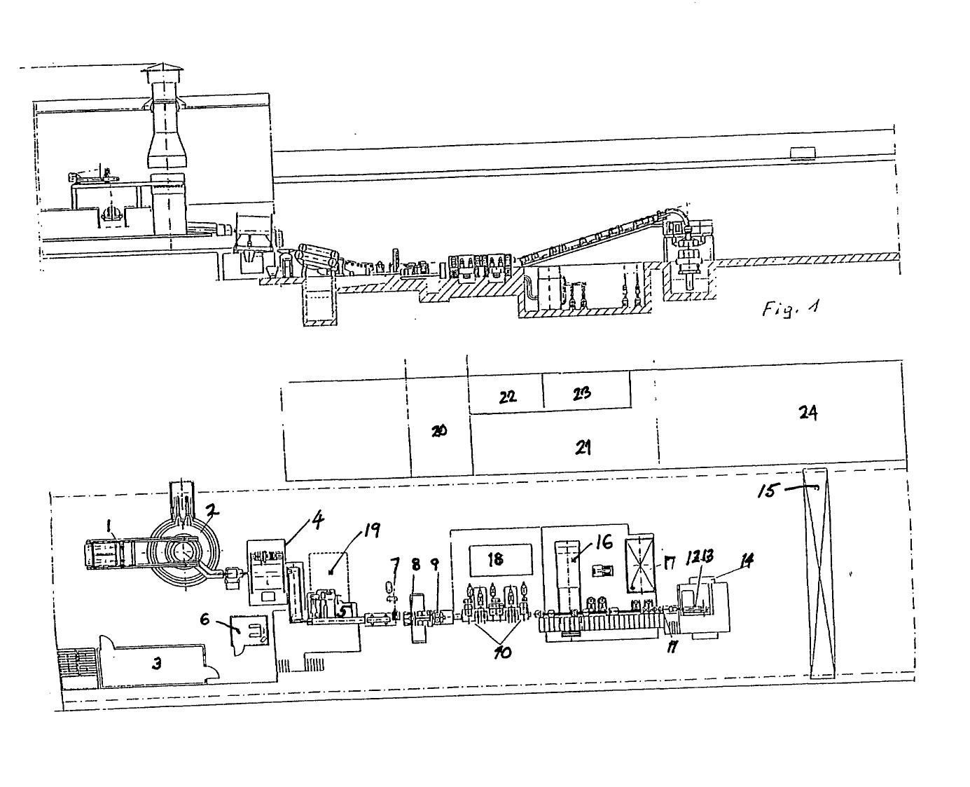

FIG. 1 shows, in the upper part, a diagrammatic side view of an installation, and

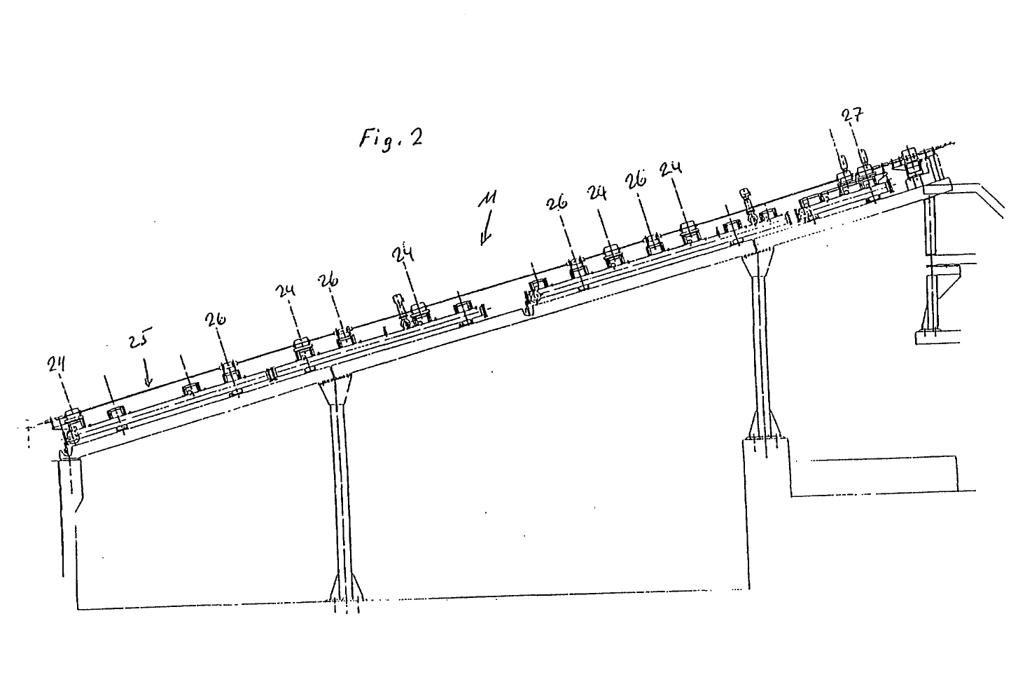

FIG. 2 shows the plan view,

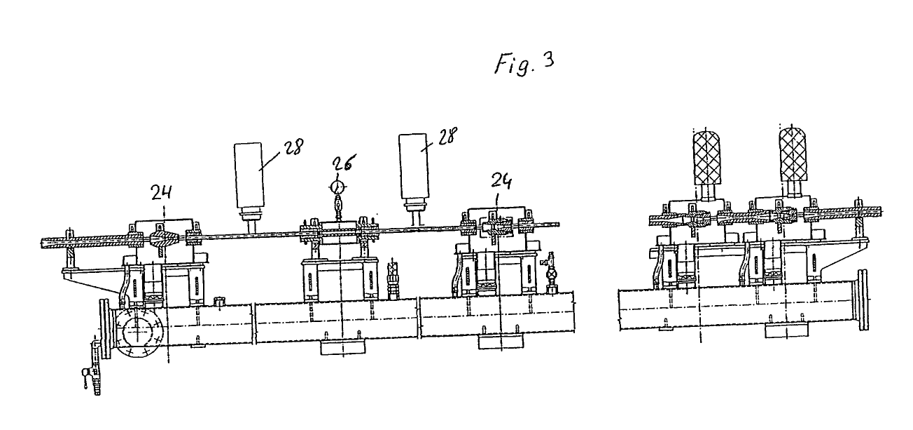

FIG. 3 shows the cooling section,

FIG. 4 shows details of the cooling section.

In FIG. 1, the shaft melting furnace is denoted by 2. Upstream of this furnace there is a charging device, by means of which the charge material is fed to the furnace. The charging and melting are monitored from the main furnace control desk 3.

The melt which leaves the shaft melting furnace passes via a holding furnace 4 into a double-strip casting machine 5, the monitoring and control of the casting operation taking place at the control stand 6. Downstream of the casting machine there is a drive unit 7, pendulum shears 8 and an edge-milling machine 9. 10 denotes the rolling mill, and 11 denotes the cooling and descaling section, which is explained in detail in the remaining figures. At the end of the installation there is a laying head 12, a coil laying chamber 13 and a coil car 14. A crane 15 is used to transfer the coils. An emulsion installation 16, which has an automatic emulsion filter, a cleaner recirculation installation 17, an oil recirculation installation 18, the cooling water sump 19 for the casting machine, the hydraulic installation 20, the electrics 21, with the transformer room 23, and finally the workshop 24, are also indicated in the drawing.

FIG. 2 shows an enlarged view of the cooling section 11. In detail, mechanical strippers 24, cooling tubes 25, cooling nozzles 26 and air strippers 27 are provided along the cooling section.

FIG. 3 shows—on a further enlarged scale—the ultrasonic transducers 28 which are arranged between the mechanical stripper 24 and the cooling nozzle 26 and by means of which the reducing liquid is moved intensively within the cooling section 11.

1. A process for cleaning oxidized, rolled copper rods which, after casting in a continuously operating continuous-casting device, emerge from a rolling mill arranged downstream of the continuous-casting device and which, on emerging from the rolling mill, have oxidic layers on their surface, characterized
a) in that the strand being rolled is wetted with an emulsion, to which a hydrocarbon-containing reducing agent has been admixed, as early as during the hot-rolling process,
b) in that the oxidized, finish-rolled rod is passed through one or more reduction zones at a temperature of approximately 650° C.,
c) in that a dilute, aqueous hydrocarbon-containing solution is used as reducing liquid in the reduction zone(s),
d) the quantity of reducing liquid used in the descaling section being limited to approx. 10% to 35% of the total quantity of circulating liquid for the descaling and cooling section,
e) in that the nonacidic, liquid reducing agent is continuously recirculated, cooled and the pH and chemical composition of the recirculated reducing agent are kept constant,
f) in that the rate at which the chemical reactions for reduction of the two types of oxide which are present proceeds is made more intensive by making the bath turbulent by means of one or more ultrasound sources,
g) in that in one or more subsequent cooling segments the cooling of the rolled rod takes place intensively using a large quantity of the reducing liquid, and
h) in that the rod is dried by means of mechanical strippers, which are acted on by compressed air, before the deoxidized rod is coated with a wax to protect against renewed oxidation.

2. The process as claimed in claim 1, characterized in that one or more ultrasound sources which operate in the frequency range from 20-100 kHz are used to make the chemical and physical operations in the descaling segments more intensive.

3. The process as claimed in claim 1, characterized in that one or more ultrasound sources which operate in the frequency range from 100-500 kHz are used to make the chemical and physical operations in the descaling segments more intensive.

4. The process as claimed in claim 1, characterized in that one or more ultrasound sources which operate in the frequency range from 500-3000 kHz are used to make the chemical and physical operations in the descaling segments more intensive.

5. The method as claimed in one of the preceding claims, characterized in that one or more ultrasound sources are also used in the cooling segments to activate the cooling processes or make them more intensive.

6. The process as claimed in claim 1, characterized in that in a) a water/oil/alcohol mixture is used as emulsion.

7. The process as claimed in claim 1, characterized in that isopropyl alcohol is used as hydrocarbon-containing reducing agent.

8. The process as claimed in claim 1, characterized in that ethanol is used as hydrocarbon-containing reducing agent.
